(19) United States
(12) Patent Application Publication
(10) Pub. No.: US 2003/0177124 A1
(43) Pub. Date: Sep. 18, 2003

(54) System for searching secure servers

(76) Inventor: Al Sauri, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 10/100,660

(22) Filed: Mar. 18, 2002

(51) Int. Cl. G06F 7/00

(52) U.S. Cl. 707/10

(57) ABSTRACT

A system to index data stored in a plurality of servers includes determination of a plurality of network addresses, each of a plurality of the plurality of network addresses associated with a respective one of a plurality of servers, access of a secure repository of shared documents managed by one of the plurality of servers using a network address associated with the server, identification of a document associated with the repository, determination of one or more keywords based on the document, generation of an index entry associated with the document, the index entry including metadata identifying at least one or more of the one or more keywords and the document, access of a second secure repository of shared documents managed by a second one of the plurality of servers using a network address associated with the second server, identification of a second document associated with the second repository, determination of a second one or more keywords based on the second document, and generation of a second index entry associated with the second document, the second index entry including second metadata identifying at least one or more of the second one or more keywords and the second document.

### BACKGROUND

1. Field

The present invention relates to systems for processing data. More specifically, the present invention concerns, in some aspects, systems for performing automated searches of shared data maintained by secure servers.

2. Discussion

Current networking technology allows users to access data stored in remote and disparate systems. As a result, networked users are capable of accessing vast amounts of data. Such access is minimally useful without a system to identify and access data of interest.

For example, the World Wide Web (“Web”) provides users with access to countless networked documents. At any give time, however, a user is interested only in a minute fraction of these documents. Accordingly, a user requires a system to locate these documents of interest and to provide access thereto.

A Web crawler is one type of system for providing these functions to a user. A Web crawler accesses Websites provided by Web servers in communication with the Web, analyzes documents maintained by the Websites, and builds an index including document details and data usable to access the documents. Some Web crawlers perform the above functions continuously and/or periodically so that the index remains relatively up-to-date.

A user searches the index to identify documents of interest. In one example, a user submits search terms to a server maintaining the index and receives a list of documents that are somehow related to the search terms. Included in the list are hyperlinks to the listed documents. By virtue of these features, Web crawlers offer a convenient way of locating and accessing Web documents.

Current Web crawlers are unable to index documents stored in secure servers or other secure repositories. Therefore, even if a user is authorized to access several secure repositories, the user will be unable to use a Web crawler index to search for documents stored in the repositories. The foregoing shortcoming is particularly onerous in the case of corporate networks, which often include several secure repositories of shared documents.

In a specific example, Lotus™ QuickPlace™ server is a tool that offers team members a central Web-accessible repository, or QuickPlace, for posting and converting documents, creating and responding to discussion items, and storing document attachments. A single user may be authorized to access several QuickPlaces and to thereby access documents and attachments maintained therein. In this regard, Lotus also provides a search engine which receives search terms from a user and locates documents and/or attachments maintained by a QuickPlace that correspond to the search terms. However, since no existing tool provides efficient searching of relevant documents in two or more QuickPlaces, a user must perform a search using the search engine for each QuickPlace to which the user has access.

In view of the foregoing, what is needed is a system to efficiently and effectively index and/or search multiple secure repositories of shared documents.

### BRIEF DESCRIPTION

In order to address the foregoing, embodiments of the present invention concern a system, a method, an apparatus, a computer-readable medium storing processor-executable process steps, and means to determine, for each of a plurality of documents maintained by each of a plurality of QuickPlaces, keywords associated with a document, and store the determined keywords in association with identifiers identifying the documents to which the keywords are associated.

In other embodiments, a plurality of network addresses are determined, each of a plurality of the plurality of network addresses associated with a respective one of a plurality of servers, a secure repository of shared documents managed by one of the plurality of servers is accessed using a network address associated with the server, a document associated with the repository is identified, one or more keywords are determined based on the document, an index entry associated with the document is generated, the index entry including metadata identifying at least one or more of the one or more keywords and the document, a second secure repository of shared documents managed by a second one of the plurality of servers is accessed using a network address associated with the second server, a second document associated with the second repository is identified, a second one or more keywords based on the second document are determined, and a second index entry associated with the second document is generated, the second index entry including second metadata identifying at least one or more of the second one or more keywords and the second document.

A technical content of some embodiments of the invention is an improved ability to index and/or locate documents stored in a plurality of secure repositories. With this and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a diagram of a system architecture according to some embodiments of the invention.

FIG. 2 is a block diagram illustrating an internal architecture of a QuickPlace server according to some embodiments of the present invention.

FIG. 3 is a block diagram illustrating an internal architecture of an index server according to some embodiments of the present invention.

FIG. 4 is a block diagram illustrating an internal architecture of a user device according to some embodiments of the present invention.

FIG. 5 is a tabular representation of a portion of a server.nsf file according to some embodiments of the present invention.

FIG. 6 is a tabular representation of a portion of a QuickPlace main.nsf file according to some embodiments of the present invention.

FIG. 7 is a tabular representation of a portion of a master.nsf file according to some embodiments of the present invention.

FIGS. 8A through 8C illustrate a flow diagram of process steps to index a plurality of secure data repositories according to some embodiments of the invention.

FIG. 9 illustrates a flow diagram of process steps to search an index of a plurality of secure data repositories according to some embodiments of the invention.

FIG. 10 is an outward view of an interface for inputting search terms according to some embodiments of the present invention.

FIG. 11 is an outward view of an interface for displaying search results according to some embodiments of the present invention.

FIG. 12 is an outward view of an interface for administering a system according to some embodiments of the present invention.

FIG. 13 illustrates a flow diagram of process steps to remove index entries from an index according to some embodiments of the invention.

### DETAILED DESCRIPTION

System Architecture

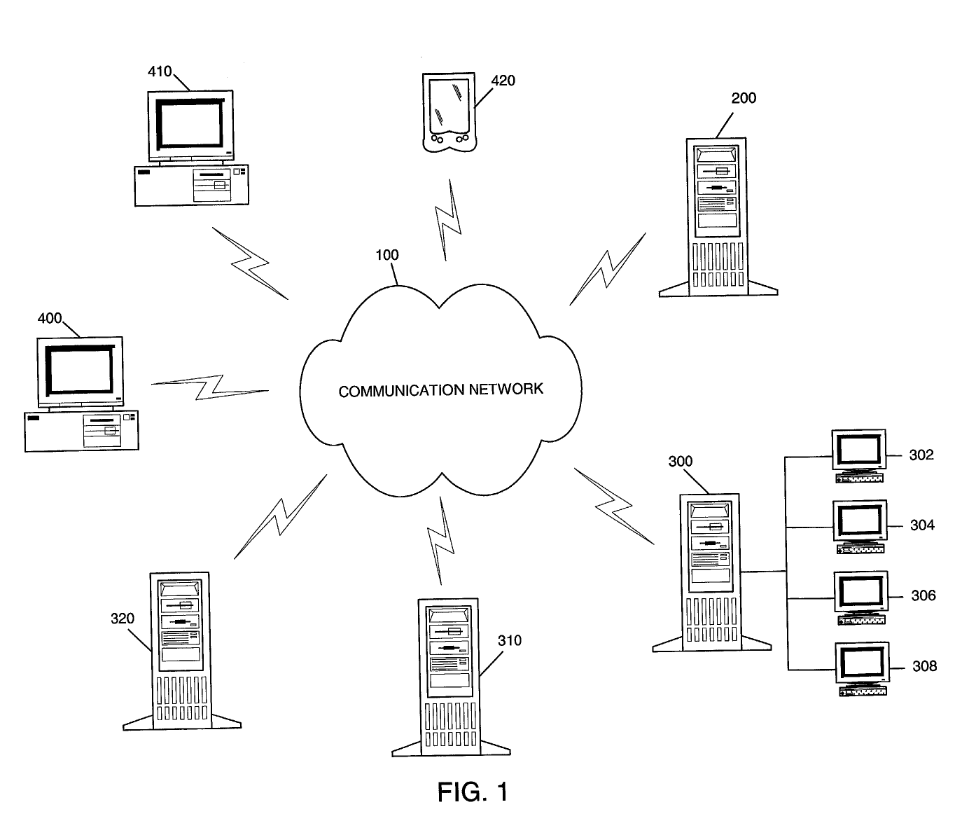

FIG. 1 illustrates an architecture of a system according to some embodiments of the invention. It should be noted that other architectures may be used in conjunction with embodiments of the invention. Shown in FIG. 1 is communication network 100 in communication with index server 200, QuickPlace servers 300 through 320, and user devices 400 through 420.

Communication network 100 may comprise any number of different systems for transferring data, including a local area network, a wide area network, a telephone network, a cellular network, a fiber-optic network, a satellite network, an infra-red network, a radio frequency network, and any other type of network which may be used to transmit information between devices. Moreover, communication between communication network 100 and each of the depicted devices may proceed over any one or more currently or hereafter-known transmission protocol, such as Asynchronous Transfer Mode (ATM), Internet Protocol (IP), Hypertext Transfer Protocol (HTTP) and Wireless Application Protocol (WAP). In some embodiments, all data is transmitted over the World Wide Web.

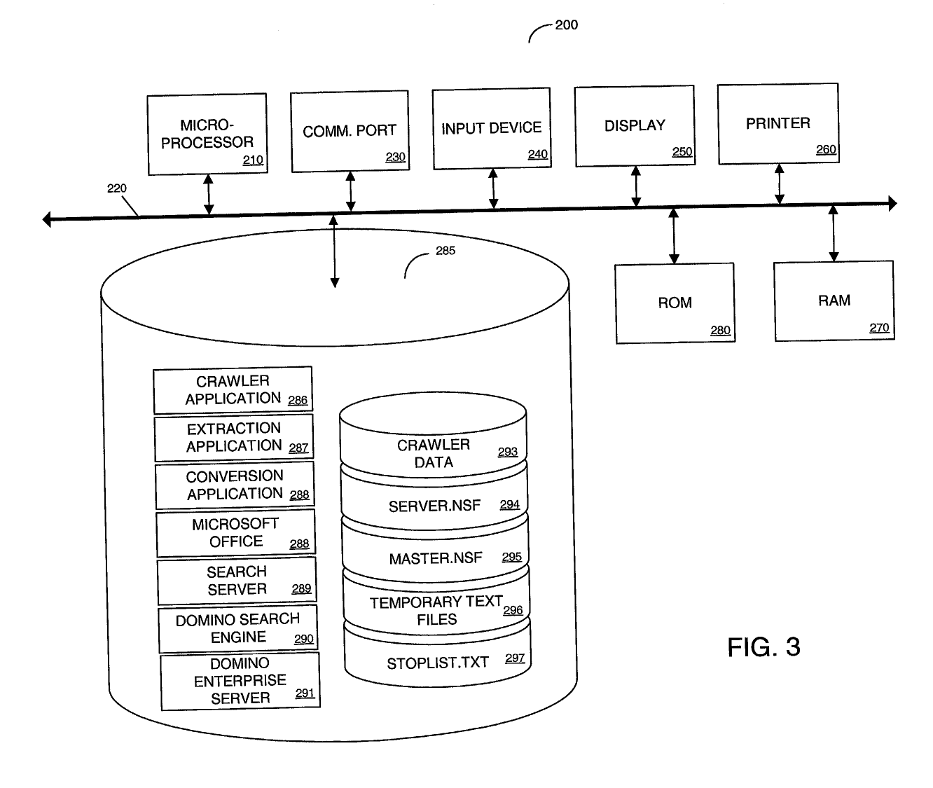

Index server 200 operates to index contents of QuickPlace servers such as servers 300 through 310. Index server 200 is depicted as a server tower in FIG. 1, but may comprise any device or devices capable of performing process steps attributed to index server 200 herein. According to some embodiments, index server 200 operates to determine, for each of a plurality of documents maintained by each of a plurality of QuickPlaces, keywords associated with a document, and to store the determined keywords in association with identifiers identifying the documents to which the keywords are associated. Index server 200 may be operated by an entity that also operates the QuickPlaces indexed by index server 200, by an entity providing indexing and/or searching services, or by another entity. Of course, index server 200 may provide functions in addition to those described herein with respect to embodiments of the invention. Elements of an embodiment of index server 200 are described in detail below with respect to FIG. 3.

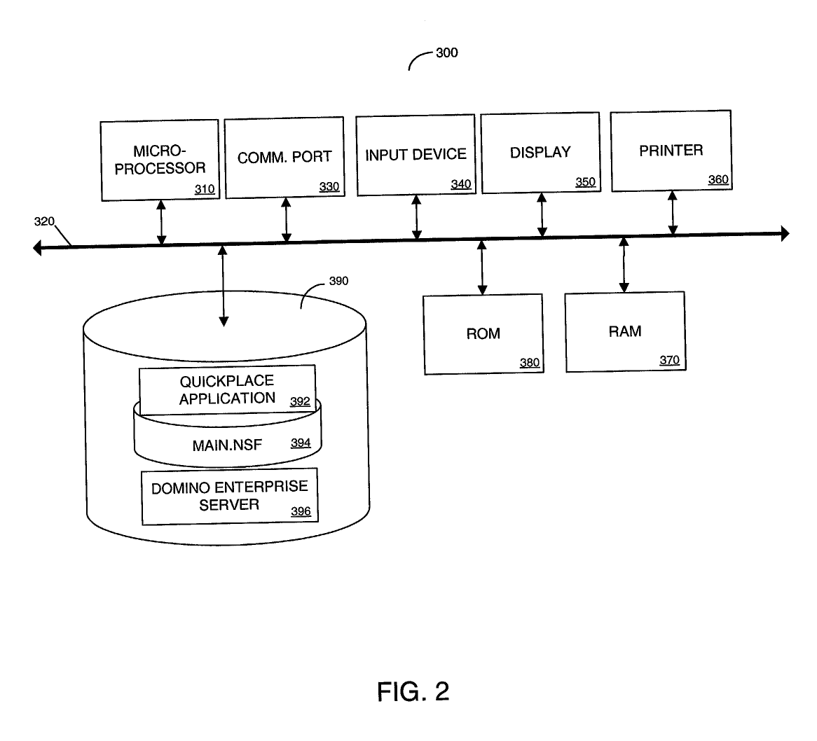

Each of QuickPlace servers 300 through 320 may comprise any device for providing one or more QuickPlaces. As shown, server 300 provides server functionality to user terminals 302 to 308. Such functionality may or may not include indexing and/or searching capabilities according to embodiments of the invention. In this regard, server 300 may act as one or more of a file server, a print server, a Web server, or other server. A QuickPlace server according to some embodiments of the invention is described below with respect to FIG. 2.

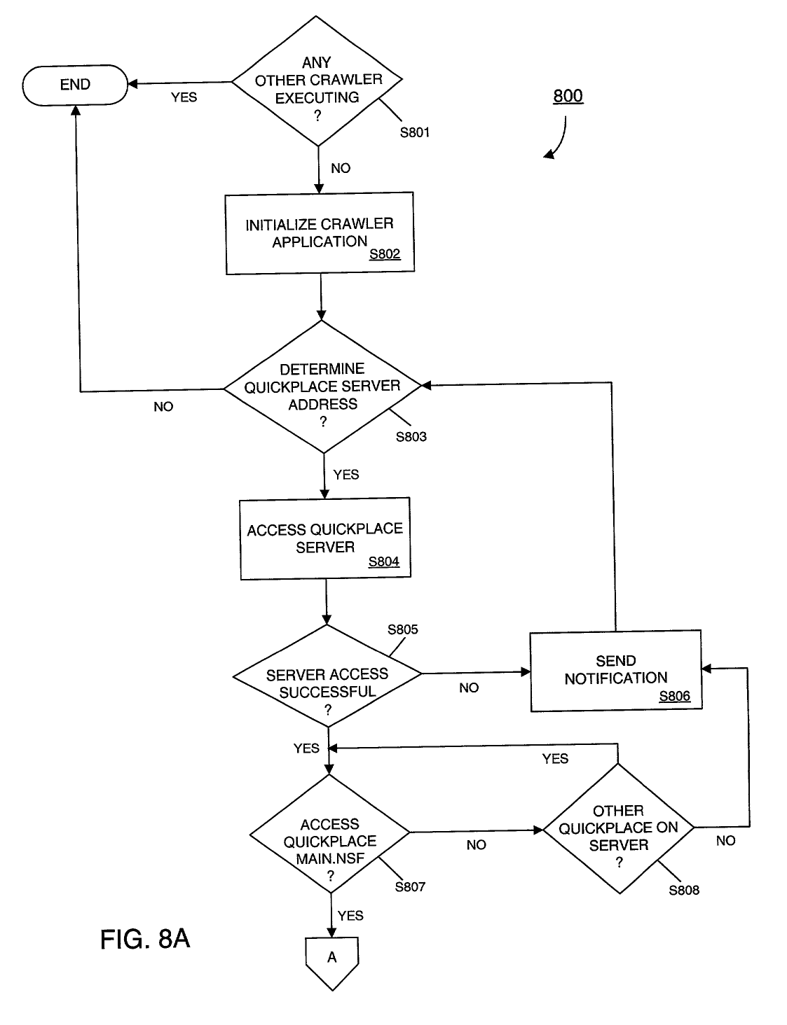

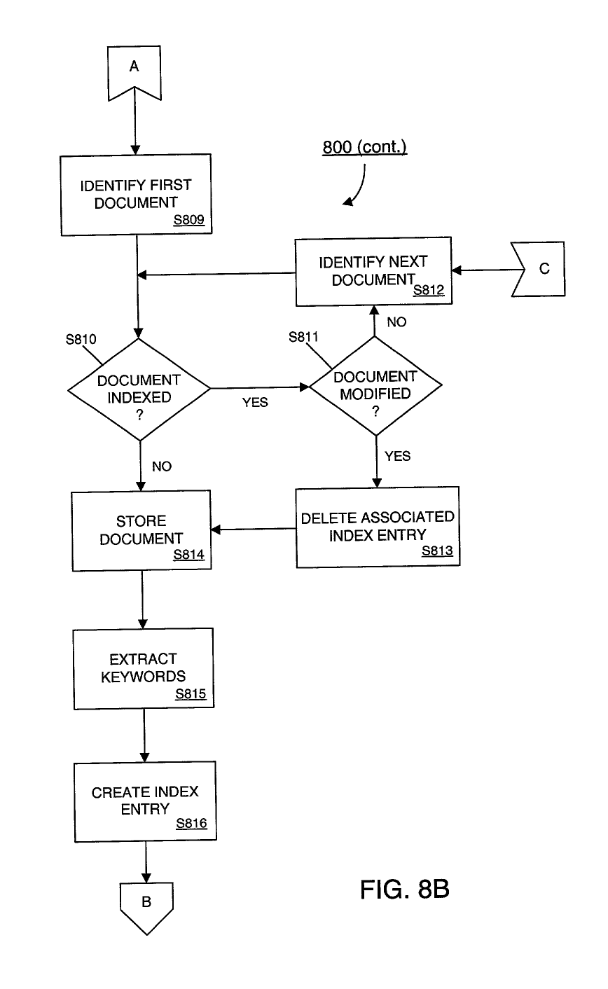

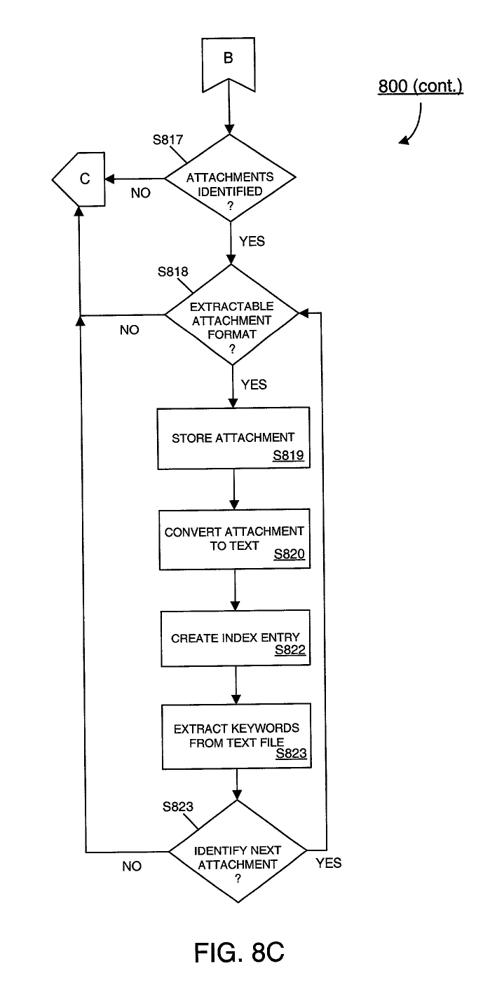

User devices 400, 410 and 420 comprise a personal computer, a personal computer and a Personal Digital Assistant, respectively. Any of user devices 400 through 420 may be used to search a plurality of QuickPlaces according to some embodiments of the invention. In one specific example, user device 420 executes a Web browser and receives a command to access a Web page hosted by index server 200. After the Web page is received by user device 420, a user inputs search terms into the Web page and the page is transmitted to server 200. Index server 200 searches an index for documents and/or attachments maintained by a plurality of QuickPlace servers and returns a Web page to user device 420 including links to several documents and/or attachments satisfying the search terms. Further details of this one example are set forth below with respect to FIGS. 8A through 8C.

The devices of FIG. 1 may be connected differently than as shown. For example, some or all of the devices may be connected directly to one another. Of course, some embodiments of the invention include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

QuickPlace server

FIG. 2 is a block diagram of an internal architecture of QuickPlace server 300 according to some embodiments of the invention. As illustrated, QuickPlace server 300 includes microprocessor 310 in communication with communication bus 320. Microprocessor 310 may comprise a 733 MHz Pentium™ III microprocessor or other type of processor and is used to execute processor-executable process steps so as to control the elements of QuickPlace server 300 to provide desired functionality.

Also in communication with communication bus 320 is communication port 330. Communication port 330 is used to transmit data to and to receive data from devices external to QuickPlace server 300 such as index server 200 and user devices 400 through 420. Such data may include a QuickPlace document, a QuickPlace attachment, data for certifying a remote server, data requesting a document and/or attachment, and other data transmitted and/or received during interactions with QuickPlaces. Communication port 330 is therefore preferably configured with hardware suitable to physically interface with desired external devices and/or network connections. For example, communication port 330 may comprise an Ethernet connection to a local area network through which QuickPlace server 300 may receive and transmit information over the Web.

Input device 340, display 350 and printer 360 are also in communication with communication bus 320. Any known input device may comprise input device 340, including a keyboard, mouse, touch pad, voice-recognition system, or any combination of these devices. Of course, information may also be input to QuickPlace server 300 via communication port 330. Display 350 may be an integral or separate CRT display, flat-panel display or the like used to display graphics and text in response to commands issued by microprocessor 310. Printer 360 may also present text and graphics to an operator, but in hardcopy form using ink-jet, thermal, dot-matrix, laser, or other printing technologies. Elements 340 through 360 are most likely used sparingly during operation of QuickPlace server 300, and may be used most often for setup and administration.

RAM 370 is connected to communication bus 320 to provide microprocessor 310 with fast data storage and retrieval. In this regard, processor-executable process steps being executed by microprocessor 310 are typically stored temporarily in RAM 370 and executed therefrom by microprocessor 310. ROM 380, in contrast, provides storage from which data can be retrieved but to which data cannot be stored. Accordingly, ROM 380 is used to store invariant process steps and other data, such as basic input/output instructions and data used during boot-up of QuickPlace server 300 or to control communication port 330. It should be noted that one or both of RAM 370 and ROM 380 may communicate directly with microprocessor 310 instead of over communication bus 320.

Data storage device 390 stores, among other data, processor-executable process steps of QuickPlace application 392. QuickPlace application 392 is provided by Lotus and may be executed by QuickPlace server 300 to provide one or more QuickPlaces to specified users. In this regard, each provided QuickPlace is associated with one main.nsf file 394. The associated main.nsf file 394 is stored in the folder domino/data/quickplace/<QuickPlace name>and comprises a data structure used to store shared documents and attachments. Not shown in FIG. 2 are a search.nsf file and a contacts.nsf file, which, according to current QuickPlace protocol, are also stored within the folder of an associated QuickPlace. Each provided QuickPlace is also associated with a LocalDomainServerGroup data field that identifies a domain to which the QuickPlace belongs.

It should be noted that the documents stored in main.nsf 394 are Lotus Notes™ documents, which may include mail memos, calendar entries, text, graphics, buttons, hotspots, objects, tables, and other data types. Moreover, the attachments associated with each document may include data such as executable files, spreadsheet files, presentation files, word processing files, compressed files, Web pages, and database files. Of course, as mentioned above, embodiments of the present invention may operate in conjunction documents other than Lotus Notes documents, such as text files, Web pages, or the like. In these embodiments, “attachments” may be defined as other documents or objects that are associated to a document in any currently or hereafter-known manner.

Along these lines, embodiments of the invention may be used in conjunction with secure repositories of shared documents that are different from QuickPlaces. These embodiments may therefore employ data structures different from QuickPlace main.nsf files, and documents and attachments that are different from Lotus Notes documents and attachments.

Domino Enterprise Server™ 396 is an application that should be installed in data storage device 390 according to current QuickPlace specifications. In embodiments where Domino Enterprise Server 396 comprises Version 5.0.3 or above, QuickPlace application 392 may be included in Domino Enterprise Server 396. Generally, a device maintaining one or more secure repositories of shared documents and used in conjunction with the present invention should include hardware and software components that are known to provide such repositories.

Also stored in data storage device 390 may also be other unshown elements that may be necessary for operation of QuickPlace server 300, such as an operating system, a database management system, other applications, other data files, and “device drivers” for allowing microprocessor 310 to interface with devices in communication with communication port 330. These elements are known to those skilled in the art, and are therefore not described in detail herein.

Index server

Index server 200 and user device 400 are described below and illustrated herein as including distinct components that are identified using names identical to some components of QuickPlace server 300. It should be noted that these distinct components may comprise any of the specific examples offered with respect to identically-named components of QuickPlace server 300. Of course, specific functions performed by the components may differ from the functions performed by the identically-named components.

In this regard, FIG. 3 illustrates several components of index server 200 according to some embodiments of the invention. Communication port 230 may be used to request access to documents and attachments maintained by a QuickPlace server, to receive requested documents and attachments, receive search queries and to transmit data identifying documents and/or attachments corresponding to the search queries. These steps may be performed in response to commands that are input by an operator using input device 240. Moreover, display 250 and printer 260 may output messages and reports to the operator relating to indexing and searching of QuickPlaces according to some embodiments of the invention. Input device 240, display 250 and printer 260 may also be used in conjunction with other applications provided by index server 200 which are unrelated to the present invention.

Data storage device 285 stores processor-executable process steps of crawler application 286, extraction application 287, conversion application 288, Microsoft Office™ application 289, search server 290, Domino search engine 291, and Domino Enterprise server 292. Also as shown, storage device 285 stores crawler data 293, server.nsf file 294, master.nsf file 295, temporary text files 296, and stoplist.txt file 297. The stored files are used to provide indexing and searching of a plurality of QuickPlace servers according to some embodiments of the invention.

More specifically, microprocessor 210 executes the stored process steps to determine, for each of a plurality of documents maintained by each of a plurality of QuickPlaces, keywords associated with a document, and store the determined keywords in association with identifiers identifying the documents to which the keywords are associated. In some embodiments, the process steps are executed so that a plurality of network addresses are determined, each of a plurality of the plurality of network addresses associated with a respective one of a plurality of servers, a secure repository of shared documents managed by one of the plurality of servers is accessed using a network address associated with the server, a document associated with the repository is identified, one or more keywords are determined based on the document, an index entry associated with the document is generated, the index entry including metadata identifying at least one or more of the one or more keywords and the document, a second secure repository of shared documents managed by a second one of the plurality of servers is accessed using a network address associated with the second server, a second document associated with the second repository is identified, a second one or more keywords based on the second document are determined, and a second index entry associated with the second document is generated, the second index entry including second metadata identifying at least one or more of the second one or more keywords and the second document.

The process steps stored in data storage device 285 may be read from one or more of a computer-readable medium, such as a floppy disk, a CD-ROM, a DVD-ROM, a Zip™ disk, a magnetic tape, or a signal encoding the process steps, and then stored in data storage device 285 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Turning to the specific files stored in data storage device 285, crawler application 286 allows index server 200 to access a plurality of QuickPlaces and to retrieve documents and attachments therefrom. Crawler data 293 includes data used by crawler application 286, such as a crawler.ini file (not shown) that specifies a path to server.nsf file 294, a path to master.nsf file 295, and a mail address and mail server name for receiving mail relating to QuickPlace indexing. In more detail, server.nsf file 294 includes, for each QuickPlace to be indexed, a QuickPlace name, an IP address and a status. The IP addresses are used by crawler application 286 to access the named QuickPlaces. After a document is retrieved from an accessed QuickPlace, the document is stored as a text file in temporary text files 296. Crawler application 286 then determines metadata of the document and extraction application 287 extracts keywords from the document using stoplist.txt file 297. Crawler application 286 then stores a record associating the metadata and the keywords with a document identifier in master.nsf file 295.

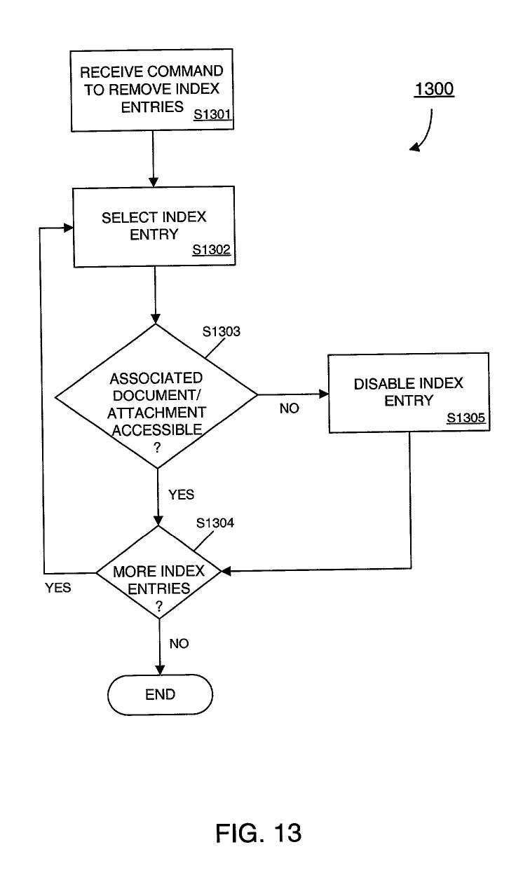

Crawler application 286 may also be used as described above to retrieve document attachments. Retrieved attachments are stored among temporary text files 296 and converted by conversion application 288 into text files. In a case that the retrieved attachments are in a Microsoft Office format such as .doc, xls, or .ppt, conversion application uses code provided by Microsoft Office application 289 to perform the conversion. Of course, embodiments of the present invention may extract keywords from and process attachments other than or in addition to attachments having an Office format. Crawler application 286 determines metadata associated with retrieved attachments, extraction application 287 extracts keywords from the stored text files and crawler application 286 stores in master.nsf file 295 records that associate, for each attachment, metadata, any keywords, and an attachment identifier. In some embodiments, crawler application 286 includes process steps executable to remove records associated with unavailable documents and/or attachments. An example of these process steps is described below with respect to FIG. 13.

Process steps of search server 290 are executed to receive search queries from user devices such as user device 400. Domino search engine 291 is used to evaluate the search queries against metadata and keywords stored in master.nsf file 295, and to determine documents and/or attachments associated with relevant metadata and keywords. Identifiers corresponding to the determined documents and/or attachments are then transmitted to the user devices, where the identifiers may be used to access the documents and/or attachments. It should be noted that the foregoing steps, which will be described in detail below with respect to FIGS. 8A through 8C, are performed according to some but not all embodiments of the invention.

Data storage device 285 also may store other files that may be necessary for operation of index server 200 and for the provision of functions unrelated to the present invention. The stored files may include processor-executable process steps of a Web server. These process steps may be executed by microprocessor 210 to transmit data to and to receive data from Web clients, such as Web browsers, over the Web. Such data may include the above-described search queries and transmitted identifiers. Domino Enterprise server 292 may also provide a platform for communicating with QuickPlaces over the Web or other network.

User device

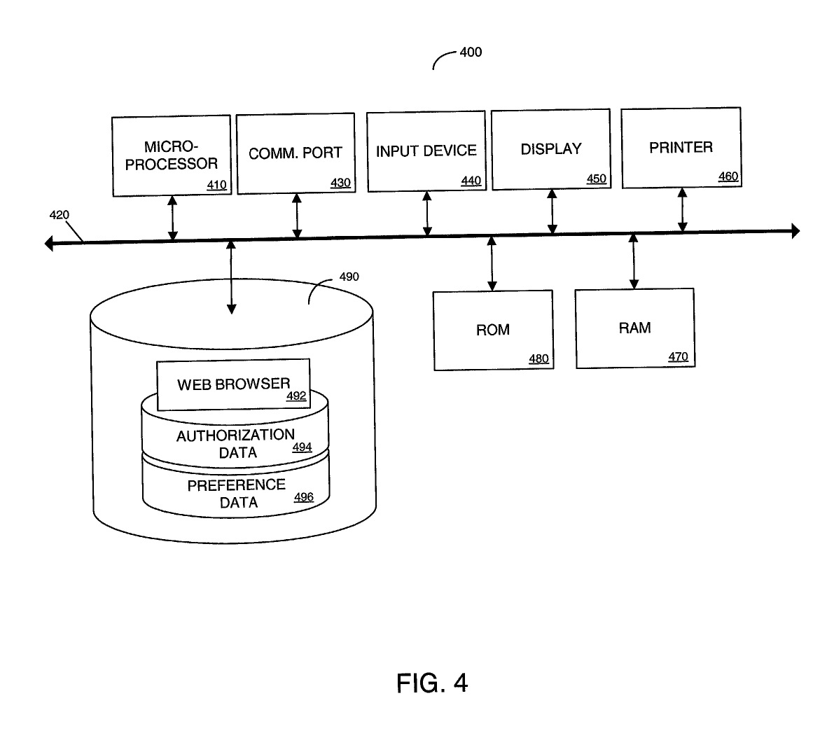

FIG. 4 illustrates several components of user device 400 according to some embodiments of the invention. As briefly described above, communication port 430 may be used to transmit search queries to and to receive document and/or attachment identifiers from index server 200. In this regard, input device 240 may be used by a user to input search queries into a user interface presented by 250 and to input commands to output the received identifiers via printer 260. Input device 240, display 250 and printer 260 may also be used in conjunction with other applications provided by user device 200 which are unrelated to the present invention.

Storage device 490 of user device 400 stores processor-executable process steps of Web browser 492. The process steps may be executed by microprocessor 410 to allow communication with Web servers such as the Web server provided by Domino Enterprise server 292 of index server 200. Authorization data 494 includes information used to determine whether a user of user device 400 is authorized to access particular QuickPlaces. For example, authorization data 494 may include usernames and passwords for accessing QuickPlaces and/or other secure repositories. After establishing communication with such a repository, user device 400 transmits an appropriate username and password from authorization data 494, based on which the repository determines whether and to what it should provide the user with access. The information stored in authorization data 494 may comprise Web cookies.

The information of preference data 496 may also comprise Web cookies. Preference data 496 may be transmitted to a QuickPlace server so that the server may customize its content and the delivery thereof to the user's particular preferences. In one example, preference data 496 may specify that the user of user device 400 prefers to receive search results ordered by document date. This preference information may be transmitted to or retrieved by index server 200 during a search so that index server 200 may present search results accordingly.

Storage device 490 may store one or more of other applications, data files, device drivers and operating system files needed to provide functions other than those directly related to the present invention. Such functions may include calendaring, e-mail access, word processing, accounting, presentation development and the like.

Data files

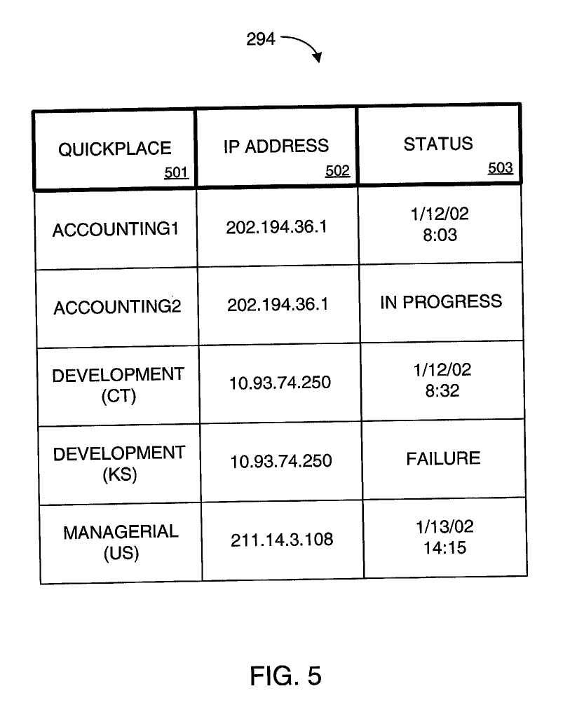

A tabular representation of a portion of server.nsf file 294 is shown in FIG. 5. The information stored in server.nsf file 294 may be entered by an operator of index server 200 through input device 240 or may be received from another device such as QuickPlace server 300 or user device 400 over communication network 100. The stored information is used to access QuickPlaces in order to index the contents thereof and to monitor the status of the indexing process.

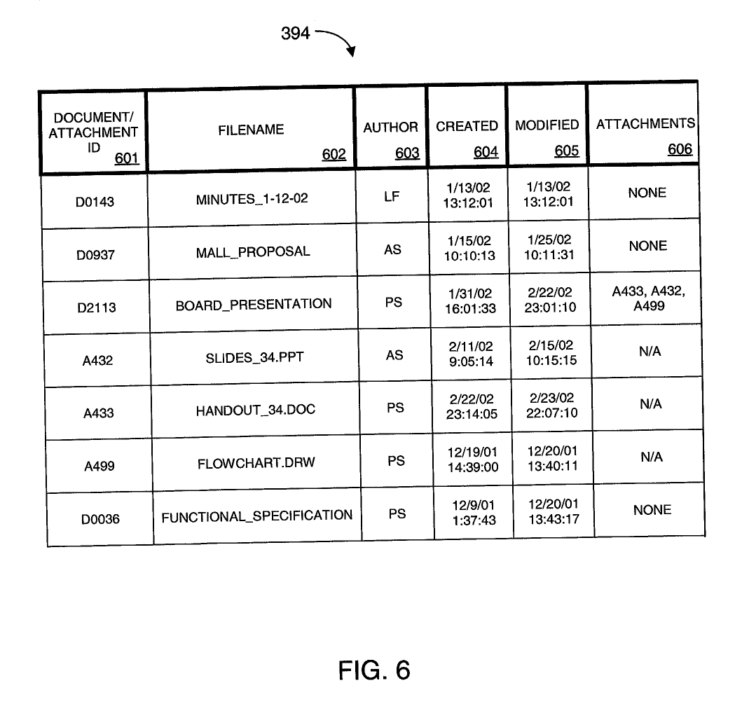

Server.nsf file 294 includes several records and associated fields. The fields include QuickPlace field 501, IP address field 502, and status field 503. QuickPlace field 501 specifies a particular QuickPlace by name. The specified QuickPlace may be identical to a name of a QuickPlace server that manages the QuickPlace or may be a different name. IP address field 502 indicates an IP address of a QuickPlace server that manages the QuickPlace identified by associated QuickPlace name 501. Accordingly, to access data maintained by a particular named QuickPlace, the IP address of the QuickPlace server that manages the QuickPlace is identified in IP address field 502 and is used to establish communication with the QuickPlace server. Next, the QuickPlace name is used to identify the folder of the server that is of interest. In this regard, and as mentioned above, data maintained by a named QuickPlace is stored in the folder domino/data/quickplace/<QuickPlace name>. As shown in FIG. 6, one IP address may be associated with more than one QuickPlace, thereby indicating that the QuickPlace server associated with the one address manages the more than one QuickPlace.

Status field 503 is used to track the indexing of an associated QuickPlace. Status field 503 may therefore indicate that indexing of a QuickPlace is currently progressing, indexing has failed, or a time at which indexing was completed. Of course, other statuses may be specified in status field 503. Specific usage of servers.nsf file 292 will be discussed with respect to FIGS. 8A through 8C.

FIG. 6 illustrates a tabular representation of a portion of main.nsf file 394. The file includes a plurality of records, each including metadata associated with a document stored in main.nsf file 394. The metadata associated with a document may be input by a user who issued a command to store the document in main.nsf file 394, by an operator of QuickPlace server 300, or in some other manner. The portion of main.nsf file 394 shown in FIG. 6 reflects documents maintained by a single QuickPlace. As mentioned above, QuickPlace server 300 may manage more than one QuickPlace, in which case QuickPlace server 300 will store more than one main.nsf file.

The fields of main.nsf file 394 include document/attachment ID field 601, filename field 602, author field 603, created field 604, modified field 605 and attachments field 606. Document ID field 601 of a particular record includes an identifier of a document or attachment that is the subject of the particular record. The identifier may comprise a thirty-two digit hexadecimal universal ID that uniquely identifies a document in a repository. In other examples, the identifier comprises a code or designator used to identify a document/attachment, as shown, or a network address or Uniform Resource Locator (URL) of the document/attachment. Filename field 602 specifies a name of the document/attachment, while author field 603, created field 604 and modified field 605 indicate the creator, creation time, and last modification time of the document attachment. Attachment(s) field 606 is populated for records associated with a document, and identifies attachments to the associated document. As shown, the attachments may be identified using associated attachment IDs.

The documents and attachments reflected in main.nsf file 394 may be stored in an associated QuickPlace by users of the QuickPlace using conventional QuickPlace protocols. According to some of these protocols, some of the data of main.nsf file 394 is input by such users during storage of the documents/attachments. Of course, some of the data, such as the data of created field 604 and modified field 605, may be automatically generated.

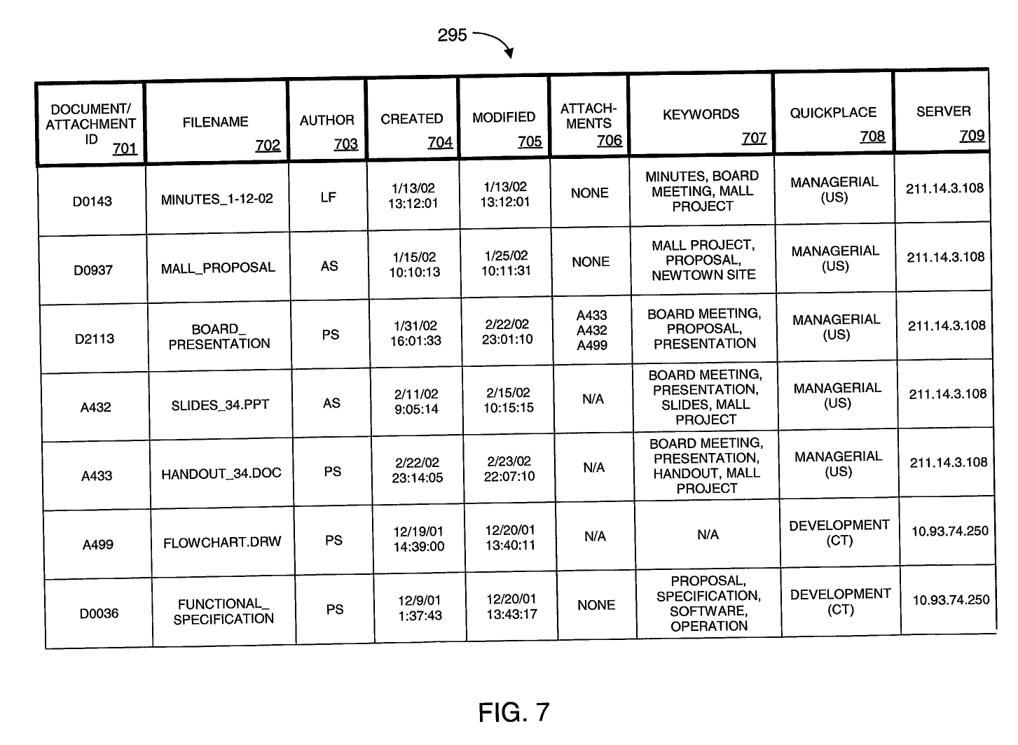

FIG. 7 illustrates a tabular representation of a portion of master.nsf file 295. The representation includes records associated with the documents and attachments reflected in FIG. 6. More specifically, FIG. 7 illustrates index entries created based on the document/attachment information shown in FIG. 6. Details of this creation will be described below.

The fields of master.nsf file 295 include document/attachment ID field 701, filename field 702, author field 703, created field 704, modified field 705, attachment field 706, keywords field 707, QuickPlace field 708 and server field 709. In some embodiments, fields 701 through 706 include the data described above with respect to identically-named fields of main.nsf file 394. Regarding the remaining fields, keyword field 707 of a record includes keywords extracted from a document or attachment associated with the record. QuickPlace field 708 and server field 709 specify a QuickPlace that maintains the document/attachment and a server that manages the QuickPlace. The QuickPlace and the server may be designated in any manner that allows identification thereof. It should be noted that a particular server specified in field 709 may be associated with one or more different QuickPlaces.

The fields of master.nsf file 295 include metadata and other data used to identify index entries in response to a received search query. For example, the data may be used to identify documents and/or attachments created on a certain date, by a certain author, and containing certain keywords. As will be described below, identifiers associated with the identified documents and/or attachments may then be transmitted to the query's sender.

It should be noted that the data files described with respect to FIGS. 5 through 7 are in .nsf (Notes Storage File) format according to some embodiments of the invention. The tabular illustrations and accompanying descriptions of the databases merely represent relationships between stored information. A number of other arrangements may be employed besides those suggested. It is further contemplated that each of server.nsf file 294, main.nsf file 394 and master.nsf file 295 may include many more records than those shown and that each record may include associated fields other than those illustrated.

Indexing

FIGS. 8A through 8C comprise a flow diagram of process steps 800 according to some embodiments of the present invention. Process steps 800 are described below as if embodied in crawler application 286 and executed by microprocessor 210 of index server 200. However, process steps 800 may be embodied in one or more software or hardware elements and executed, in whole or in part, by any device or by any number of devices in combination, including QuickPlace server 300. Moreover, some or all of process steps 800 may be performed manually.

Briefly, process steps 800 may be executed to determine, for each of a plurality of documents maintained by each of a plurality of QuickPlaces, keywords associated with a document, and to store the determined keywords in association with identifiers identifying the documents to which the keywords are associated. In some embodiments of process steps 800, a plurality of network addresses are determined, each of a plurality of the plurality of network addresses associated with a respective one of a plurality of servers, a secure repository of shared documents managed by one of the plurality of servers is accessed using a network address associated with the server, a document associated with the repository is identified, one or more keywords are determined based on the document, an index entry associated with the document is generated, the index entry including metadata identifying at least one or more of the one or more keywords and the document, a second secure repository of shared documents managed by a second one of the plurality of servers is accessed using a network address associated with the second server, a second document associated with the second repository is identified, a second one or more keywords based on the second document are determined, and a second index entry associated with the second document is generated, the second index entry including second metadata identifying at least one or more of the second one or more keywords and the second document.

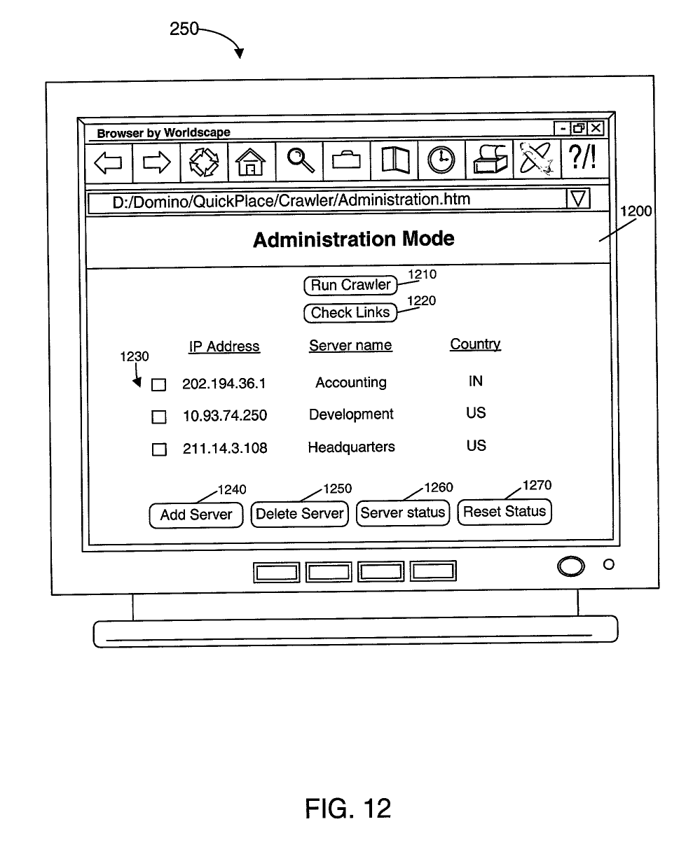

Process steps 800 may be performed periodically, in response to a triggering event, or on command from an operator of index server 200, as described below with respect to FIG. 12. Turning to the specific steps, it is determined in step S801 whether any other crawling program is being executed by index server 200. If so, flow terminates. If not, crawler application 286 is initialized in step S802. Initialization may comprise determining the name of the index file and the list of servers to be searched from crawler data 293. In the present example, the index file is master.nsf file 295 and the list is located in server.nsf file 294. In some embodiments, the list is determined from a Domino server list view of server.nsf file 294. Initialization in step S802 may also include determination of an electronic mail address and a name of an outgoing electronic mail server (SMTP, IMAP or the like) usable to send an electronic mail message to an operator of index server 200. This information may also be stored in crawler data 293.

Determination of an address of a QuickPlace server is then attempted in step S803. The determination may proceed by attempting to read an IP address from the data determined in step S802. If, for example, no network addresses of any QuickPlace servers were determined from server.nsf file 294, the attempt of step S803 is deemed unsuccessful and process steps 800 terminate. It will be assumed for the purposes of the present example that the information shown in server.nsf file 294 of FIG. 6 is used to initialize crawler application 286 in step S802. It will also be assumed that IP address 211.14.3.108, associated with the QuickPlaces “Development (CT)” and “Managerial (US)”, is determined in step S803. The determined address is then used to access an associated QuickPlace server in step S804.

The associated QuickPlace server is accessed using TCP/IP and a Domino ID of index server 200. The Domino ID, or server ID, is stored in a configuration file of Domino Enterprise Server 291 and uniquely identifies index server 200. Domino IDs uniquely identify users as well as servers. The Domino system uses information included in these IDs to control the access of users and servers to other servers and applications. More particularly, the IDs are used during a process intended to provide secure access to a Domino server.

According to the process, a Domino ID is created each time a new user or server is created on a Domino network. Two security procedures are performed whenever a user or a Domino server attempts to communicate with a Domino server for replication, mail routing or database access, and each of these procedures uses information included in the ID. First, the public key of the accessor is validated. If validation is successful, the identity of the accessor is verified during a process known as authentication. Authentication uses the public and private keys of the accessor in a challenge/response interaction.

If both index server 200 and the QuickPlace server accessed in step S804 are in a same domain, each will have a common certifier within their respective Domino IDs. According to embodiments of the invention, no cross-certification is required if it is determined that index server 200 and the accessed QuickPlace server are in the same domain. Conversely, the two servers are cross-certified in a case that their certifiers do not match, thereby indicating that the two servers are in different domains.

In step S805, it is determined whether the attempt to access the QuickPlace server in step S804 was successful. The attempt may not succeed for many reasons. Specifically, the QuickPlace server may be offline or otherwise unable to communicate over communication network 100, the server ID of index server 200 may not have database access privileges, and the server associated with the used IP address may no longer manage any QuickPlaces or may not exist. Regardless of the reason for unsuccessful access, an electronic mail notification detailing the unsuccessful access is transmitted in step S806 to the operator of index server 200 using the electronic mail address and the outgoing electronic mail server determined in step S802. In some embodiments, the flag “Failure” is stored in status field 503 of an associated record of server.nsf file 294. Flow then returns to step S803, where a new QuickPlace address is determined from server.nsf file 294.

If it is determined in step S805 that the QuickPlace server was successfully accessed, then access of a main.nsf file of a QuickPlace managed by the QuickPlace server is attempted in step S807. If, as in the present example, the accessed QuickPlace server manages more than one QuickPlace, then one of the QuickPlaces must be selected for access in step S807. If the access is not successful, flow proceeds to step S808 to determine if the accessed QuickPlace server manages other QuickPlaces. If not, flow returns to step S806 to send an electronic mail notification and to indicate the failure in an appropriate record of server.nsf file 294 as described above.

Once a main.nsf file of a QuickPlace is successfully accessed, a first document maintained by the QuickPlace is identified in step S809. For example, document “D0143” is identified in step S809 after successful access of QuickPlace “Managerial (US)”. Step S809 may also comprise populating status field 503 associated with the accessed QuickPlace with an “In progress” flag to indicate that indexing of the QuickPlace is progressing. Next, in step S810, it is determined whether an index entry corresponding to the document is stored in master.nsf file 295. As shown in FIG. 7, master.nsf file 295 includes an index entry corresponding to document “D0143” . Therefore, it is determined in step S810 that the document has been indexed and flow continues to step S811.

In step S811, it is determined whether the document has been modified since storage of its corresponding record in master.nsf file 295. The determination of step S811 may proceed by comparing the time associated with the document in modified field 705 with the time associated with the document in modified field 605. In the present example, a time specified by modified field 705 is identical to the time associated with the document by modified field 605. Therefore, the record of master.nsf file 295 corresponding to document “D0143” was created and stored after the document was last modified.

Because the document has not been modified since storage of its corresponding index entry, flow continues to step S812 to identify another document in the QuickPlace. If no documents remain, flow returns to step S808. Document “D0937” is identified according to the present example, therefore flow returns to step S810, where it is determined that the document has been indexed. Next, in step S8 11, it is determined that the document has been modified since storage of its corresponding index entry in master.nsf file 295. This determination is made because modified field 605 associated with the record specifies a time later than the time associated with the subject QuickPlace in status field 503. The index entry is deleted in step S813 and flow continues to step S814. In this regard, flow continues to step S814 from step S810 if a document identified in steps S809 or S812 has no corresponding index entry in master.nsf file 295.

A copy of the document is stored in step S814 among temporary text files 296. This storage facilitates further processing of the file by index server 200. Keywords are extracted from the stored document in step S815. The keywords may be extracted using extraction application 287 and stoplist.txt file 297. Particularly, extraction application 287 is executed to identify words of the document that are not included in stoplist.txt file 297. In this regard, stoplist.txt file 297 includes common words that are judged to be of minimal use as keywords.

After the keywords have been extracted, an index entry is created in step S816. To create an index entry, crawler application 286 determines metadata associated with the document, such as data of associated fields of main.nsf file 394. This metadata may be determined at any time during and between step S807 and step S816. Next, an index entry is created and stored in master.nsf file 295, the index entry associating a document identifier with the determined metadata and the extracted keywords.

In step S817, attachments associated with the document are identified. Flow returns to step S812 if no attachments are identified. Assuming that document “D2113” is the document of interest in step S817, attachment(s) field 606 specifies that attachments are associated with the document, therefore flow continues to step S818. In step S818, it is determined whether a first of the identified attachments is in a format from which keywords can be extracted. According to the presently-described embodiment, keywords can be extracted from attachments formatted according to a Microsoft Office format. The first identified attachment associated with document “D2113” is in .ppt format, therefore the determination in step S818 is affirmative. Accordingly, the attachment is stored among temporary text files 296 in step S819. Conversely, the determination of step S818 would be negative in view of attachment “A433” and flow would thereafter return to step S812.

Conversion application 288 executes along with elements of Microsoft Office application 289 to convert the stored attachment to a text file. Keywords are extracted from the text file in step S821 as described above with respect to step S815, and an index entry associated with the attachment is created in step S822. The index entry is created based on metadata associated with the attachment in a corresponding record of main.nsf file 394 and on the extracted keywords. FIG. 7 illustrates master.nsf file 295 storing index entries associated with attachments and documents according to some embodiments of the present invention.

A next attachment associated with the subject document is identified in step S823. If no other attachments are associated with the document, flow returns to step S812. Flow cycles as described above until each document and attachment of each accessible main.nsf file 394 maintained by each QuickPlace listed in server.nsf file 294 is processed.

Each time flow reaches step S808 after successful creation of index entries associated with documents and/or attachments of a QuickPlace, a current time is recorded in status field 503 associated with the QuickPlace. It should be noted that modification of a document according to the present example includes modification of any attachment associated with the document. Accordingly, steps S813 through S816 may be performed if an attachment associated with a document has changed, an even if the document has been unchanged since creation of an index entry associated with the document. Process steps 800 may be modified so as to only perform steps S813 through S816 if a document has changed since creation of an index entry associated with the document. Of course, such modification may require a determination after step S817 of whether a subject attachment has changed since creation of an index entry associated therewith.

Searching

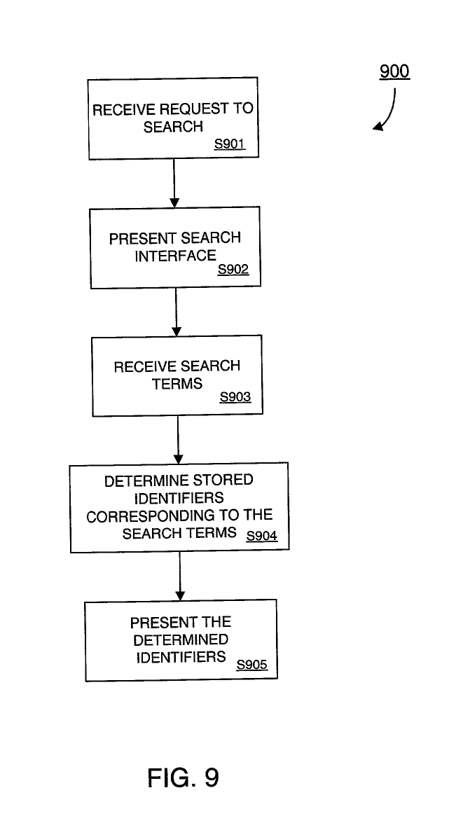

FIG. 9 illustrates process steps 900. Process steps 900 provide searching of index entries created according to some embodiments of the present invention. Process steps 900 may be embodied in processor-executable process steps of search server 290 and executed by microprocessor 210. Of course, some or all of process steps 900 may be embodied in other applications, formats or devices, and some of process steps 900 may be performed manually.

Process steps 900 begin at step S901, in which index server 200 receives a request to search a plurality of QuickPlaces maintained by a plurality of QuickPlace servers. The request may be received from user device 400. More specifically, user device 400 may execute Web browser 492 to provide a user with access to the World Wide Web. Web browser 492 displays a user interface on display 450, and the user may input a URL into or select a hyperlink displayed by the user interface. In the present example, the URL or hyperlink points to a search page maintained by index server 200 through search server 289. Accordingly, index server 200 receives a request for the search page from user device 400, the request comprising a request to search indexed QuickPlaces. In this regard, search server 289 may comprise process steps to provide a Web server.

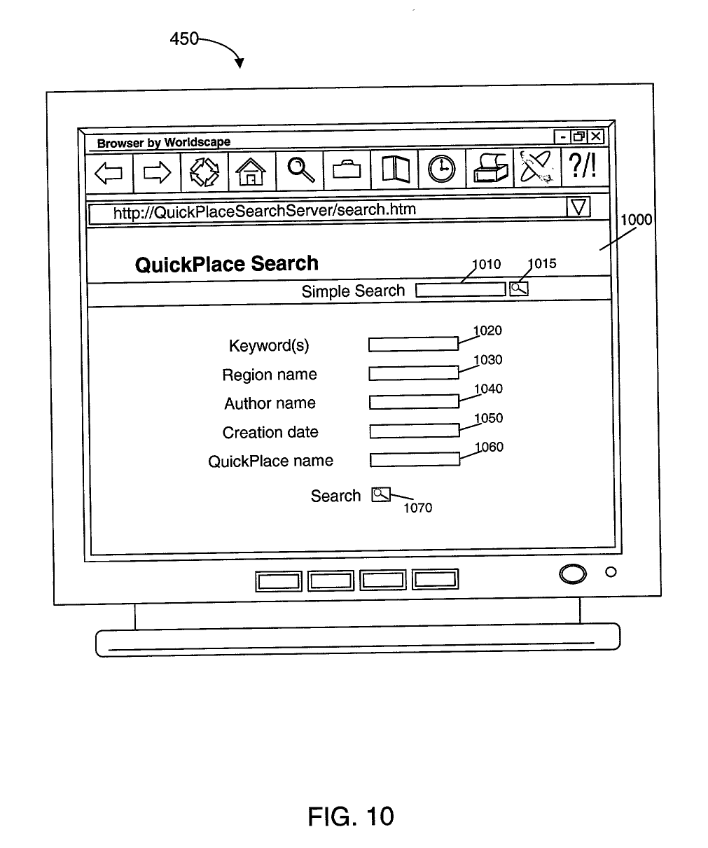

A search page including a search interface is transmitted to user device 400 in step S902. FIG. 10 is an outward view of search page 1000 as displayed by display 450 according to some embodiments of the invention. As shown, search page 1000 includes simple search input field 1010 for inputting search terms using input device 440. Search button 1015 may be selected to transmit search terms input into field 1010 to index server 200. Accordingly, field 1010 and button 1015 may be used to quickly transmit search terms to server 200.

Keyword(s) input field 1020 allows a user to input search terms comprising keywords. Similarly, region name input field 1030, author name input field 1040, creation date input field 1050, and QuickPlace name input field 1060 allow a user to input search terms comprising a region name, an author name, a creation date, and a QuickPlace name, respectively. Of course, other types of search terms may be used in accordance with some embodiments of the invention. Moreover, input fields 1010, 1020, 1030, 1040, 1050 and 1060 may comprise pull-down menus or other input techniques.

Search button 1070 is selected to transmit search terms contained in input fields 1010, 1020, 1030, 1040, 1050 and 1060 to index server 200. Such search terms are received by communication port 230 in step S903. Next, in step S904, stored identifiers are determined based on the received search terms. According to some embodiments, the search terms are compared against the metadata and keywords associated with each record of master.nsf file 295. For example, in a case where a user has input “LF” into author name input field 1040, master.nsf file 295 is analyzed to identify those records including “LF” in author field 703. In some embodiments, more than one field of master.nsf file 295 is analyzed to identify search terms input into one of input fields 1010, 1020, 1030, 1040, 1050 or 1060.

A document identifier associated with the identified record is then determined. The document identifier may comprise data specified in document/attachment ID field 701 of the record and/or filename field 702. As mentioned above, document/attachment ID field 701 of a record, and therefore the determined identifier, may comprise a URL of a document/attachment associated with the record.

Step S904 may be performed by executing process steps of Domino search engine 290. According to some embodiments, Domino search engine 290 is used to determine a relevance of identified records to the received search terms. Step S904 may be performed using different processes, software and/or hardware for identifying records based on search terms or for determining a relevance of the identified records.

The determined identifiers are presented in step S905. This presentation may comprise transmission of the determined identifiers to the device from which the request was received in step S901. In some embodiments, a Web page is constructed including the determined identifiers, and a relevance, a QuickPlace, and a modification date of the document/attachment associated with each identifier. Construction of the Web page may be based on preference data received from preference data 496 of user device 400. In some embodiments, the Web page includes only identifiers associated with documents/attachments to which the requestor has access. Such access may be determined from authorization data 494 of user device 400. The constructed Web page is transmitted to user device 400 for display by Web browser 492.

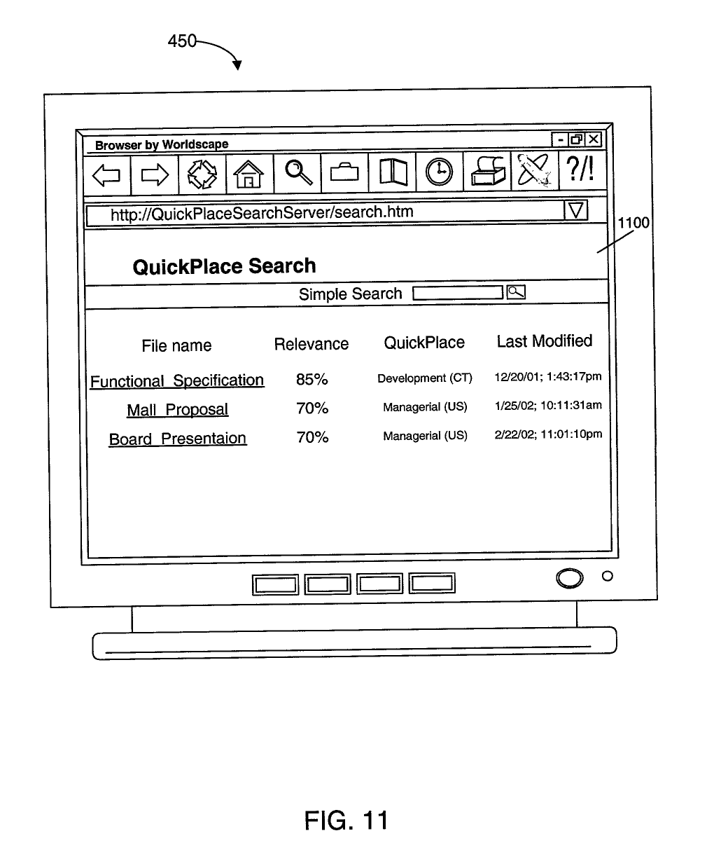

FIG. 11 shows an outward view of display 450 after receipt of such a Web page. Web page 1100 includes several determined identifiers, listed under the heading “Filename”. For each identifier, Web page 100 shows a relevance, a QuickPlace, and a modification date of the document/attachment associated with each identifier. In some embodiments, the displayed identifiers are selectable to access an associated document/attachment. In this regard, the displayed identifier may comprise a hyperlink associated with a URL of the identified document/attachment. The URL may be displayed or encoded behind another identifier, such as a filename.

In some embodiments, selection of an identifier causes user device 400 to transmit a request for the associated document/attachment to a QuickPlace maintaining the document/attachment. The request may include data from authorization data 494 that will be used by the QuickPlace to determine whether to grant access to the document/attachment. The QuickPlace may also or alternatively request authorization data from user device 400 after receiving the request.

FIG. 12 shows display 250 of index server 200 during an administration mode. Display 250 shows user interface 1200 that is displayed to an operator to allow administration of a system according to some embodiments of the present invention. As shown, user interface 1200 comprises a Web page accessed by a Web browser executed by index server 200, but it should be noted that interface 1200 may be provided by a dedicated application. A Web-based embodiment allows the operator to enter the administration mode using a Web browser located remote from index server 200.

Interface 1200 includes button 1210, which is selectable to initiate an indexing process such as that defined by process steps 800. Button 1220 is used to disable records from master.nsf file 295 that correspond to inactive, unavailable, or deleted documents and/or attachments. One embodiment of this disabling will be described below with respect to FIG. 13.

Also displayed by user interface 1200 are an IP address, server name and country associated with each QuickPlace server specified in server.nsf file 294. Process steps 800 were described as attempting to index each QuickPlace server specified in server.nsf file 294. In some embodiments, checkboxes 1230 allow the operator to specify one or more QuickPlace servers to index. Specifically, the operator selects one or more QuickPlace servers using checkboxes 1230 and selects button 1210 to index the selected QuickPlace servers. According to some embodiments, button 1220 may also or alternatively be selected to remove records from the selected QuickPlace servers.

Button 1240 may be selected to add a QuickPlace server to servers.nsf file 294. More particularly, the operator is prompted after selection of button 1240 to input information associated with the server to be added, including an IP address, a name, a country, or the like. The added server is then included in user interface 1200 and may be indexed according to some embodiments of the present invention.

Button 1250 may be selected to delete a server from server.nsf file 294. A QuickPlace server's status may be viewed or reset, respectively, through selection of button 1260 or button 1270. For any or all of buttons 1250 through 1270, one or servers are selected using checkboxes 1230 and a desired operation is performed with respect to the selected servers by selecting an appropriate button.

FIG. 13 is a flow diagram of process steps 1300 to remove index entries that correspond to inactive, unavailable, or deleted documents and/or attachments according to some embodiments of the invention. As described above, process steps 1300 maybe embodied in processor-executable process steps of crawler application 286 and performed by index server 200. Process steps 1300 may also be embodied using other hardware and/or software combinations.

Process steps 1300 begin at step S1301, in which a command is received to remove index entries from master.nsf file 295. In some embodiments, process steps 1300 are executed periodically, such as every 24 hours. Embodiments may also configure process steps 1300 to execute at certain times. In either case, the command received in step S1301 maybe triggered by a current time or may simply be an indication of a current time. As mentioned with respect to FIG. 12, the command may be received in response to selection of button 1220. If button 1220 is selected after selection, using checkboxes 1230, of less than all QuickPlace servers shown on user interface 1200, the received command may also specify that only index entries associated with the selected QuickPlace servers are to be removed. In some embodiments, all inactive index entries are removed from master.nsf file 295 irrespective of which servers are selected on user interface 1200.

An index entry of master.nsf file 295 is selected in step S1302. Field 709 of the index entry should identify a selected QuickPlace server. The contents of field 709 need not be analyzed in a case that all index entries of master.nsf file 295 are to be subjected to process steps 1300. A document/attachment associated with the selected index entry is 25 accessed in step S1303 using an associated IPaddress specified in field 709, a QuickPlace name specified in field 709, and a filename specified in field 702. Other or additional information may be used to attempt to access the document/attachment. If the document/attachment is accessed, it is determined in step S1304 whether additional index entries exist in master.nsf file 295. If additional entries exist, flow returns to step S1302 for selection of a next index entry.

If access is unsuccessful in step S1303, the index entry is disabled in step S 1305. Disabling may comprise deleting the entry from master.nsf file 295, flagging the entry as inactive, or otherwise disabling the entry so that an identifier associated therewith would not be returned as a search result in step S905 of process steps 900. Flow returns to step S1304 after removal of the entry.

As mentioned above, process steps 1300 may be executed according to a predefined schedule. Process steps 1300 may be, for instance, executed according to a first predefined schedule with respect to index entries associated with one or more QuickPlace servers, and according to a second predefined schedule with respect to index entries associated with another one or more QuickPlace servers. Predefined schedules may also be associated with documents and/or attachments maintained by one or more individual QuickPlaces.

Process steps 800, 900 and/or 1300 may be applied to secure repositories of shared documents other than QuickPlaces. Moreover, the process steps may be altered to create embodiments of the invention completely or partially different from any of the arrangements mentioned herein without departing from the spirit and scope of the present invention.

What is claimed is:

1. A method for automatically indexing a plurality of QuickPlaces maintained by a plurality of servers, comprising:
determining, for each of a plurality of documents maintained by each of a plurality of QuickPlaces, keywords associated with a document; and
storing the determined keywords in association with identifiers identifying the documents to which the keywords are associated.

2. A method according to claim 1, further comprising:
determining, for each of a plurality of attachments maintained by each of a plurality of QuickPlaces, keywords associated with an attachment; and
storing the determined keywords in association with identifiers identifying the attachments to which the keywords are associated.

3. A method according to claim 2, further comprising:
updating data stored in association with a stored identifier if it is determined that an attachment identified by the identifier has been changed.

4. A method according to claim 1, further comprising:
updating data stored in association with a stored identifier if it is determined that a document identified by the identifier has been changed.

5. A method according to claim 1, further comprising:
receiving search terms;
determining stored identifiers corresponding to the search terms; and
presenting the determined identifiers.

6. A method for indexing data stored in a plurality of servers, comprising:
determining a plurality of network addresses, each of a plurality of the plurality of network addresses associated with a respective one of a plurality of servers;
accessing a secure repository of shared documents managed by one of the plurality of servers using a network address associated with the server;
identifying a document associated with the repository;
determining one or more keywords based on the document;
generating an index entry associated with the document, the index entry including metadata identifying at least one or more of the one or more keywords and the document;
accessing a second secure repository of shared documents managed by a second one of the plurality of servers using a network address associated with the second server;
identifying a second document associated with the second repository;
determining a second one or more keywords based on the second document; and
generating a second index entry associated with the second document, the second index entry including second metadata identifying at least one or more of the second one or more keywords and the second document.

7. A method according to claim 6, further comprising:
identifying an attachment associated with the document;
determining a third one or more keywords associated with the attachment; and
generating a third index entry associated with the attachment, the third index entry including third metadata identifying at least one or more of the third one or more keywords and the attachment.

8. A method according to claim 7, further comprising:
associating the third index entry with the second index entry.

9. A method according to claim 7, wherein the step of determining the third one or more keywords associated with the attachment comprises:
converting the attachment to a text file; and
extracting keywords from the text file.

10. A method according to claim 7, further comprising:
accessing the secure repository of shared documents managed by the one of the plurality of servers using the network address associated with the server;
determining if the attachment has changed during a period after generation of the third index entry; and
if it is determined that the attachment has changed during the period, determining a fourth one or more keywords based on the document, and generating a fourth index entry associated with the changed attachment, the fourth index entry including metadata identifying at least one or more of the fourth one or more keywords and the changed attachment.

11. A method according to claim 10, wherein generation of the fourth index entry comprises updating the third index entry.

12. A method according to claim 6, wherein the method is performed periodically.

13. A method according to claim 6, wherein the step of accessing the secure repository of shared documents comprises:
determining if a domain of the one of the plurality of servers is equivalent to a domain of a system performing the method; and
cross-certifying the system and the one of the plurality of servers if the domain of the one of the plurality of servers is different from the domain of the system performing the method.

14. A method according to claim 6, further comprising:
receiving a search query;
identifying one or more stored index entries corresponding to the search query; and
transmitting the one or more stored index entries.

15. A method according to claim 14, wherein the step of identifying one or more stored index entries comprises:
identifying stored index entries including metadata identifying keywords satisfying the search query.

16. A method according to claim 14, further comprising:
receiving user privilege information,
wherein the identifying step comprises identifying one or more stored index entries corresponding to the search query and to the user privilege information.

17. A method according to claim 14, further comprising:
receiving user preference information,
wherein the identifying step comprises identifying one or more stored index entries corresponding to the search query and to the user preference information.

18. A method according to claim 14, further comprising:
receiving user preference information,
wherein the transmitting step comprises transmitting the one or more stored index entries based on the user preference information.

19. A method according to claim 6, further comprising:
accessing the secure repository of shared documents managed by the one of the plurality of servers using the network address associated with the server;
determining if the document has changed during a period after generation of the index entry associated with the document; and
if it is determined that the document has changed during the period, determining a third one or more keywords based on the document, and generating a third index entry associated with the changed document, the index entry including metadata identifying at least one or more of the third one or more keywords and the changed document.

20. A method according to claim 19, wherein generation of the third index entry comprises updating the index entry.

21. A method according to claim 6, wherein the generated index entry is stored in an index data structure and further comprising:
retrieving the stored index entry;
attempting to access the document based on the metadata included in the stored index entry; and
if the document cannot be accessed, disabling the stored index entry.

22. A method according to claim 21, and wherein the retrieving, attempting and disabling steps are performed periodically for each of a plurality of index entries stored in the index data structure.

23. A method according to claim 6, wherein the secured repository of shared documents and the second secure repository of shared documents comprise QuickPlaces.

24. A method for indexing a plurality of QuickPlaces maintained by a plurality of servers, comprising:
determining a network address associated with each of the plurality of QuickPlaces;
accessing a first one of the plurality of QuickPlaces using a network address associated with the first one of the plurality of QuickPlaces;
determining first keywords associated with a first document maintained in the first one of the plurality of QuickPlaces;
accessing a second one of the plurality of QuickPlaces using a second network address associated with the second one of the plurality of QuickPlaces;
determining second keywords associated with a second document maintained in the second one of the plurality of QuickPlaces; and
storing the first keywords in association with an identifier identifying the first document, and the second keywords in association with an identifier identifying the second document.

25. A method according to claim 24, further comprising:
receiving a search query;
identifying one or more stored identifiers based on the search query and on keywords associated with the one or more stored identifiers; and
transmitting the one or more stored identifiers.

26. A method according to claim 25, further comprising:
receiving user privilege information,
wherein the identifying step comprises identifying one or more stored identifiers based on the search query, on keywords associated with the one or more stored identifiers, and on the user privilege information.

27. A method according to claim 25, further comprising:
receiving user preference information,
wherein the identifying step comprises identifying one or more stored identifiers based on the search query, on keywords associated with the one or more stored identifiers, and on the user preference information.

28. A method according to claim 25, further comprising:
receiving user preference information,
wherein the transmitting step comprises transmitting the one or more stored identifiers based on the user preference information.

29. A method according to claim 24, further comprising:
accessing the first QuickPlace using the first network address;
determining if the first document has changed during a period after storage of the first keywords in association with the identifier identifying the first document; and
if it is determined that the first document has changed during the period, determining a third one or more keywords based on the document, and storing the third keywords in association with an identifier identifying the first document.

30. A system comprising:
a plurality of servers, each of the plurality of servers maintaining one or more secure repositories of shared documents;
an index server for determining a plurality of network addresses, each of a plurality of the plurality of network addresses associated with a respective one of the plurality of servers, for accessing a secure repository of shared documents managed by one of the plurality of servers using a network address associated with the server, for identifying a document associated with the repository, for determining one or more keywords based on the document, for generating an index entry associated with the document, the index entry including metadata identifying at least one or more of the one or more keywords and the document, for accessing a second secure repository of shared documents managed by a second one of the plurality of servers using a network address associated with the second server, for identifying a second document associated with the second repository, for determining a second one or more keywords based on the second document, and for generating a second index entry associated with the second document, the second index entry including second metadata identifying at least one or more of the second one or more keywords and the second document; and
a plurality of client devices for transmitting search queries to the index server and for receiving search results comprising identifiers of documents maintained by a plurality of the secure repositories of shared documents.

31. A computer-readable medium storing processor-executable process steps to index data stored in a plurality of servers, the steps comprising:
a step to determine a plurality of network addresses, each of a plurality of the plurality of network addresses associated with a respective one of a plurality of servers;
a step to access a secure repository of shared documents managed by one of the plurality of servers using a network address associated with the server;
a step to identify a document associated with the repository;
a step to determine one or more keywords based on the document;
a step to generate an index entry associated with the document, the index entry including metadata identifying at least one or more of the one or more keywords and the document;
a step to access a second secure repository of shared documents managed by a second one of the plurality of servers using a network address associated with the second server;
a step to identify a second document associated with the second repository;
a step to determine a second one or more keywords based on the second document; and
a step to generate a second index entry associated with the second document, the second index entry including second metadata identifying at least one or more of the second one or more keywords and the second document.

32. An indexing device, comprising:
a processor; and
a storage device in communication with the processor and storing instructions adapted to be executed by the processor to:
determine a plurality of network addresses, each of a plurality of the plurality of network addresses associated with a respective one of a plurality of servers;
access a secure repository of shared documents managed by one of the plurality of servers using a network address associated with the server;
identify a document associated with the repository,
determine one or more keywords based on the document;
generate an index entry associated with the document, the index entry including metadata identifying at least one or more of the one or more keywords and the document;
access a second secure repository of shared documents managed by a second one of the plurality of servers using a network address associated with the second server;
identify a second document associated with the second repository; p2 determine a second one or more keywords based on the second document; and
generate a second index entry associated with the second document, the second index entry including second metadata identifying at least one or more of the second one or more keywords and the second document.

33. A method according to claim 32, wherein the storage device stores the generated index entries.
